(19) United States
(12) Patent Application Publication
(10) Pub. No.: US 2006/0019144 A1
(43) Pub. Date: Jan. 26, 2006

(54) Channel-incorporating pedestal and method for producing same

(76) Inventors: Haretaro Hidaka, Mihara-shi (JP); Michio Tsukamoto, Mihara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/174,479

(22) Filed: Jul. 6, 2005

(30) Foreign Application Priority Data
Jul. 21, 2004 (JP) 2004-212904

(51) Int. Cl. H01M 2/14

(52) U.S. Cl. 429/38

(57) ABSTRACT

A channel-incorporating pedestal comprising a first plate and a second plate joined together, incorporating a groove, which is formed on a joining surface of the first plate, as a channel for a fluid, and bringing the groove into communication with an instrument, which is placed on a surface of the first plate, via a communication hole formed in the first plate, and wherein the first plate comprises an anticorrosive material, the second plate comprises a metallic material, and the fist plate and the second plate are bonded together by an adhesive protective sheet interposed between the first plate and the second plate, the adhesive protective sheet having a lower melting point than melting points of the first plate and the second plate, and being thermoplastic and anticorrosive.

### BACKGROUND OF THE INVENTION

1. Field of the Invention

This invention relates to a channel-incorporating pedestal, and a method for producing it.

2. Description of the Related Art

A channel-incorporating pedestal is applied, for example, to various systems in various industrial fields, such as a stationary fuel cell power generation system for domestic use or a movable fuel cell power generation system for installation in a vehicle, and fluid control systems, e.g., air brake systems for trains. That is, the channel-incorporating pedestal is configured such that various instruments, such as components and devices constituting these systems, are mounted on the surface of the pedestal, built-in channels (grooves) are provided in place of complicated piping connecting these instruments (the built-in channels function as the piping), and further electrical wiring is also incorporated. The channel-incorporating pedestal, so configured, is put to practical uses as compact integrated units, such as stationary units including domestic fuel cell power generation units, and moving units including vehicle-installed fuel cell power generation units.

Various proposals have been made for concrete configurational examples of the channel-incorporating pedestal. For example, those disclosed in Japanese Patent Application Laid-Open No. 2002-305010 can be named. A configurational example of a conventional channel-incorporating pedestal will be described hereinbelow with reference to FIGS. 6 to 8. FIG. 6 is a sectional view showing the configuration of the conventional channel-incorporating pedestal (a sectional view taken on line A-A of FIG. 7), FIG. 7 is a plan view taken in the direction of B in FIG. 6, and FIG. 8 is a sectional view taken on line C-C of FIG. 6.

As shown in FIGS. 6, 7 and 8, a channel-incorporating pedestal 1 comprises an upper plate 2 and a lower plate 3 joined together by publicly known friction stir welding or a suitable binder 4. Various instruments 5, such as components and devices constituting, for example, a fuel cell power generation system or a fluid control system, which are suitably placed on the surface 2a of the upper plate 2, are fixed by clamping, integrally with the upper and lower plates 2 and 3, by bolts 6 inserted through bolt holes 2b and 3a formed in the upper and lower plates 2 and 3, and nuts 7 screwed to the bolts 6. That is, the channel-incorporating pedestal 1 functions as a pedestal for mounting the instruments 5.

A groove 8 is formed in a joining surface 3b of the lower plate 3. Generally, a plurality of the grooves 8 are formed, have predetermined sectional areas, and are formed with suitable lengths in suitable directions. The upper plate 2 is joined to the lower plate 3 in such a manner as to cover the groove 8 (put a lid on the groove 8) formed in the lower plate 3. As a result, a channel for a fluid, which consists of the groove 8, is formed within the channel-incorporating pedestal 1.

Communication holes 9 are formed in the upper plate 2, and the groove 8 are brought into communication with the instruments 5 via these communication holes 9. That is, the groove 8 is incorporated, as the channel for a fluid, in the channel-incorporating pedestal 1. These built-in channels (grooves 8) have the function of piping connecting the instruments 5 together. In other words, the channel-incorporating pedestal 1 also functions as integrated piping. The sectional area of each groove 8 (built-in channel) is determined by the properties, flow velocity and pressure loss of a fluid flowing in each groove 8, and the length and direction of each groove 8 (built-in channel) are determined, for example, by the arrangement of the instruments 5.

As the material for the upper and lower plates 2 and 3, an aluminum plate is used most frequently because of its light weight, strength, and ease of processing. Other materials in frequent use are a metallic material such as a steel plate, and a metallic material such as a casting product.

There may be a case where the fluid flowing through the groove 8 and the communication hole 9 is a corrosive fluid for the metallic material constituting the upper and lower plates 2 and 3, or has a possibility for corroding the metallic material, for example, by a local cell action. In this case, the surfaces of the groove 8 and the communication hole 9, which are in contact with the fluid, are coated with an aluminum oxide film (alumite), or are subjected to corrosion protection by polytetrafluoroethylene (PTFE: Teflon®) coating. Alternatively, the upper plate 2 and the lower plate 3, as a whole, are produced, for example, from corrosion-free synthetic resin. Such measures have so far dealt with possible corrosion.

However, the measures for corrosion protection involve a complicated manufacturing process, require a long time for completion, and need a great investment in production facilities, thus entailing high costs. Moreover, the production of the upper and lower plates 2 and 3, as a whole, from corrosion-free synthetic resin poses problems, such that some reinforcement is required, and the use of the synthetic resin is feasible only when the pressure of the fluid flowing through the groove 8 is low, because the upper and lower plates 2 and 3 generally undergo marked deformation, and their mechanical strength is low.

The present invention has been accomplished in light of the above-described circumstances. It is an object of the present invention to provide a channel-incorporating pedestal having corrosion resistance, which can be produced at a low cost, and which can ensure mechanical strength, and a method for producing the channel-incorporating pedestal.

### SUMMARY OF THE INVENTION

An aspect of the present invention is a channel-incorporating pedestal

comprising a first plate and a second plate joined together,

incorporating a groove, which is formed on a joining surface of the first plate, as a channel for a fluid, and

bringing the groove into communication with an instrument, which is placed on a surface of the first plate, via a communication hole formed in the first plate, and

wherein the first plate comprises an anticorrosive material,

the second plate comprises a metallic material, and

the fist plate and the second plate are bonded together by an adhesive protective sheet interposed between the first plate and the second plate, the adhesive protective sheet having a lower melting point than melting points of the first plate and the second plate, and being thermoplastic and anticorrosive.

Another aspect of the present invention is a channel-incorporating pedestal

comprising a first plate, a second plate, and a third plate joined together, with the second plate being interposed between the first plate and the third plate,

incorporating a first groove, which is formed on a joining surface of the first plate, and a second groove, which is formed on a joining surface of the third plate, as channels for fluids,

bringing the first groove into communication with an instrument, which is placed on a surface of the first plate, via a first communication hole formed in the first plate, and

bringing the second groove into communication with an instrument, which is placed on a surface of the third plate, via a second communication hole formed in the third plate, and

wherein the first plate and the third plate comprise an anticorrosive material,

the second plate comprises a metallic material,

the fist plate and the second plate are bonded together by a first adhesive protective sheet interposed between the first plate and the second plate, the first adhesive protective sheet having a lower melting point than melting points of the first plate, the second plate, and the third plate, and being thermoplastic and anticorrosive, and

the third plate and the second plate are bonded together by a second adhesive protective sheet interposed between the third plate and the second plate, the second adhesive protective sheet having a lower melting point than melting points of the first plate, the second plate, and the third plate, and being thermoplastic and anticorrosive.

Still another aspect of the present invention is a method for producing a channel-incorporating pedestal,

the channel-incorporating pedestal

comprising a first plate and a second plate joined together,

incorporating a groove, which is formed on a joining surface of the first plate, as a channel for a fluid, and

bringing the groove into communication with an instrument, which is placed on a surface of the first plate, via a communication hole formed in the first plate,

the method comprising

using a plate comprising an anticorrosive material as the first plate,

using a plate comprising a metallic material as the second plate, and

pressurizing and heating the fist plate and the second plate, with an adhesive protective sheet being interposed between the first plate and the second plate, the adhesive protective sheet having a lower melting point than melting points of the first plate and the second plate, and being thermoplastic and anticorrosive, to melt the adhesive protective sheet, thereby bonding the first plate and the second plate together by the adhesive protective sheet.

A further aspect of the present invention is a method for producing a channel-incorporating pedestal, the channel-incorporating pedestal

comprising a first plate, a second plate, and a third plate joined together, with the second plate being interposed between the first plate and the third plate,

incorporating a first groove, which is formed on a joining surface of the first plate, and a second groove, which is formed on a joining surface of the third plate, as channels for fluids,

bringing the first groove into communication with an instrument, which is placed on a surface of the first plate, via a first communication hole formed in the first plate, and

bringing the second groove into communication with an instrument, which is placed on a surface of the third plate, via a second communication hole formed in the third plate,

the method comprising

using plates comprising an anticorrosive material as the first plate and the third plate, using a plate comprising a metallic material as the second plate,

pressurizing and heating the fist plate, the second plate, and the third plate, with a first adhesive protective sheet being interposed between the first plate and the second plate, the first adhesive protective sheet having a lower melting point than melting points of the first plate, the second plate, and the third plate, and being thermoplastic and anticorrosive, and with a second adhesive protective sheet being interposed between the third plate and the second plate, the second adhesive protective sheet having a lower melting point than melting points of the first plate, the second plate, and the third plate, and being thermoplastic and anticorrosive, to melt the first adhesive protective sheet and the second adhesive protective sheet, thereby bonding the first plate and the second plate together by the first adhesive protective sheet, and bonding the third plate and the second plate together by the second adhesive protective sheet.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a sectional view showing the configuration of a channel-incorporating pedestal according to Embodiment 1 of the present invention (a sectional view taken on line D-D of FIG. 2);

FIG. 2 is a plan view taken in the direction of E in FIG. 1;

FIG. 3 is a sectional view taken on line F-F of FIG. 1;

FIG. 4 is a sectional view showing the configuration of a channel-incorporating pedestal according to Embodiment 2 of the present invention;

FIG. 5 is a sectional view taken on line G-G of FIG. 4;

FIG. 6 is a sectional view showing the configuration of a conventional channel-incorporating pedestal (a sectional view taken on line A-A of FIG. 7);

FIG. 7 is a plan view taken in the direction of B in FIG. 6; and

FIG. 8 is a sectional view taken on line C-C of FIG. 6.

### DETAILED DESCRIPTION OF THE INVENTION

Embodiments of the present invention will now be described in detail with reference to the accompanying drawings. Embodiment 1

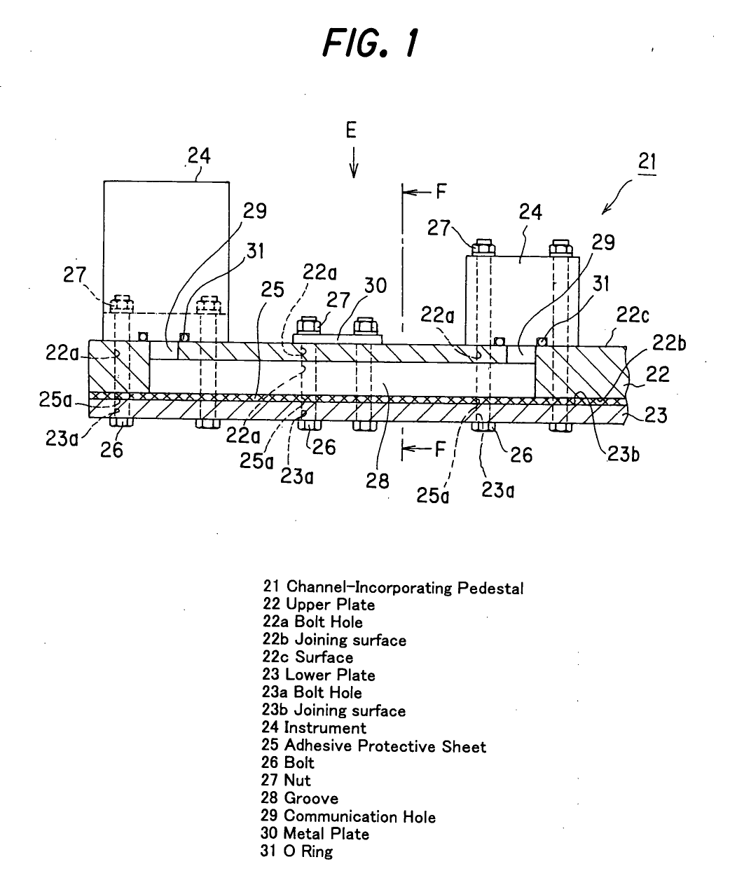

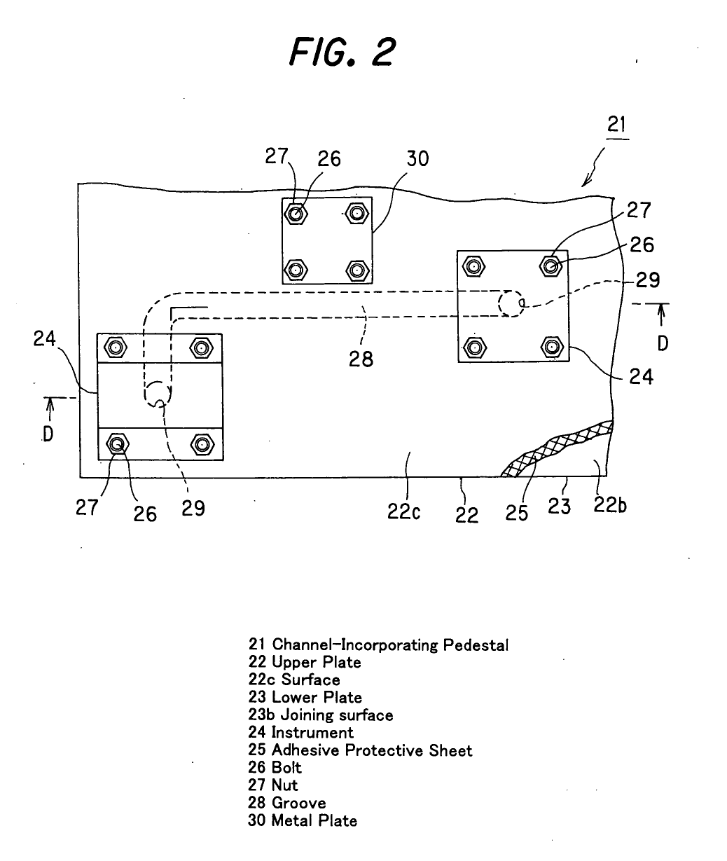

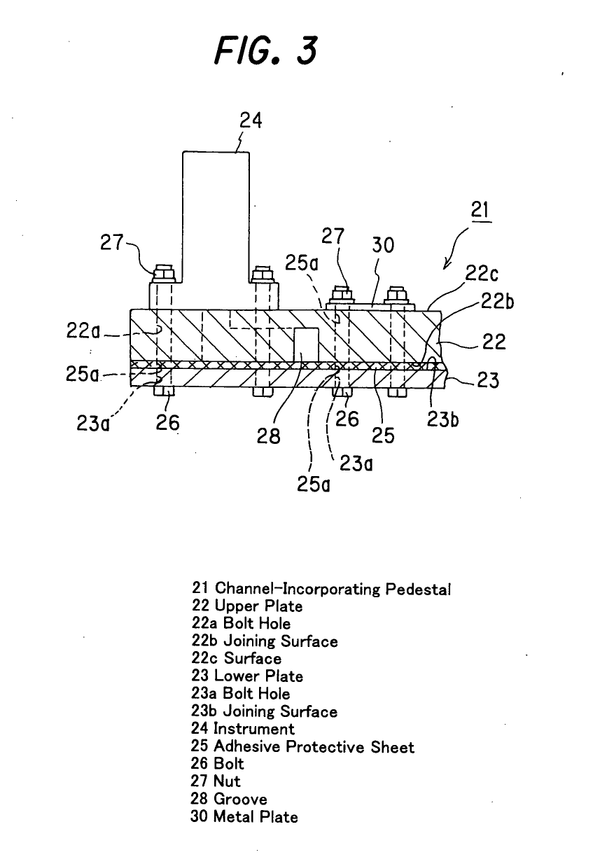

FIG. 1 is a sectional view showing the configuration of a channel-incorporating pedestal according to Embodiment 1 of the present invention (a sectional view taken on line D-D of FIG. 2), FIG. 2 is a plan view taken in the direction of E in FIG. 1, and FIG. 3 is a sectional view taken on line F-F of FIG. 1.

As shown in FIGS. 1, 2 and 3, a channel-incorporating pedestal 21 comprises an upper plate 22, as a first plate, and a lower plate 23, as a second plate, joined together. An adhesive protective sheet 25 is interposed between the upper plate 22 and the lower plate 23. Various instruments 24, such as components and devices constituting, for example, a fuel cell power generation system or a fluid control system, are placed on the surface 22c of the upper plate 22. These instruments 24 are fixed by clamping, integrally with the upper and lower plates 22 and 23, by bolts 26 inserted through bolt holes 22a, 23a and 25a formed in the upper and lower plates 22 and 23 and the adhesive protective sheet 25, and nuts 27 screwed to the bolts 26. That is, the channel-incorporating pedestal 21 functions as a pedestal for mounting the instruments 24.

A groove 28 is formed in a joining surface 22b of the upper plate 22 by suitable means such as machining, injection molding, or die casting. Generally, a plurality of the grooves 28 are formed, have predetermined sectional areas (widths and depths), and are formed with suitable lengths in suitable directions. The lower plate 23 is joined to the upper plate 22 via the adhesive protective sheet 25 in such a manner as to cover the groove 28 formed in the upper plate 22. As a result, a channel for a fluid, which consists of the groove 28, is formed within the channel-incorporating pedestal 21.

Communication holes 29 are formed in the upper plate 22, directly below the instruments 24 disposed on the upper plate 22, by suitable means such as machining, injection molding, or die casting. The groove 28 is brought into communication with the instruments 24 via these communication holes 29. That is, the groove 28 is incorporated, as the channel for a fluid, in the channel-incorporating pedestal 21. These built-in channels (grooves 28) have the function of piping connecting the instruments 24 together. Thus, the channel-incorporating pedestal 21 also functions as integrated piping. The sectional area of each groove 28 (built-in channel) is determined by the properties, flow velocity and pressure loss of the fluid flowing in each groove 28, and the length and direction of each groove 28 (built-in channel) are determined, for example, by the arrangement of the instruments 24. A clearance between the communication hole 29 and the instrument 24 is sealed with an O ring 31.

The upper plate 22 comprises a nonmetallic material having corrosion resistance, and the lower plate 23 comprises a metallic material. Examples of the corrosion-resistant material are corrosion-free synthetic resins, such as fluoroplastic plates, for example, polytetrafluoroethylene (PTFE: Teflon). As examples of the metallic material, an aluminum plate and a steel plate can be named. The thickness of the lower plate 23 is a suitable thickness for required mechanical strength.

The adhesive protective sheet 25 is a thermoplastic and corrosion-resistant one. A publicly known, commercially available product can be used as the adhesive protective sheet 25. To be selected as the adhesive protective sheet 25 is a sheet-shaped product which is based on the same material as that of the upper plate 22, which has a suitable thickness, and which comprises, for example, a thermoplastic synthetic resin well compatible with and highly adhesive to a joining surface 23b of the lower plate 23. Furthermore, the adhesive protective sheet 25 has to have a lower melting point than those of the upper plate 22 and the lower plate 23. For example, if the material for the lower plate 23 is aluminum, and the material for the upper plate 22 is PTFE, then a material having a lower melting point than the melting point of PTFE (327° C.) needs to be selected for the adhesive protective sheet 25.

A method for producing the channel-incorporating pedestal 21 will be described. First, the adhesive protective sheet 25 is sandwiched (interposed) between the upper plate 22 and the lower plate 23 throughout the surfaces of the upper and lower plates 22 and 23. Then, in this state, a suitable pressurizing means (pressing means) is applied to the upper and lower plates 22 and 23, such that the upper and lower plates 22 and 23 are clamped by a clamping device (not shown), or a heavy object is placed on the upper and lower plates 22 and 23. By this measure, the adhesive protective sheet 25, together with the upper and lower plates 22 and 23, is pressurized (given pressure) under a suitable pressurizing force. Moreover, the adhesive protective sheet 25, together with the upper and lower plates 22 and 23, is heated by a heating means, such as a baking furnace (heating furnace), to a suitable temperature at which the adhesive protective sheet 25 is melted and adhered. The pressurizing force and the heating temperature differ according to the type of the adhesive protective sheet 25. For example, the heating temperature is usually several hundred degrees centigrade.

As a result, the upper plate 22 and the lower plate 23 are bonded together by the adhesive protective sheet 25.

Concretely, at the portion of joining between the upper and lower plates 22 and 23, namely, at a portion where the adhesive protective sheet 25 contacts the joining surface 22b of the upper plate 22 and the joining surface 23b of the lower plate 23 (i.e., the portion other than the portion corresponding to the groove 28 formed in the upper plate 22), the upper and lower plates 22 and 23 are bonded by the adhesive protective sheet 25. In the non-joining portion of the upper and lower plates 22 and 23, namely, the portion corresponding to the groove 28 formed in the upper plate 22, the adhesive protective sheet 25 is fusion bonded to the joining surface 23b of the lower plate 23, coating or lining the joining surface 23b. Thus, the adhesive protective sheet 25 protects the relevant portion of the lower plate 23 from a corrosive fluid flowing in the groove 28.

Then, the instruments 24 are placed on the upper plate 22, and they are clamped by the bolts 26 and the nuts 27 for fixing, whereby sufficient strength of the bonding surfaces can be ensured. Furthermore, if it is necessary to enhance the bond strength between the upper and lower plates 22 and 23 because the fluid flowing through the groove 28 is at a high pressure, the upper and lower plates 22 and 23 and the adhesive protective sheet 25 may be clamped together by the bolts 26 and the nuts 27 via a suitable metal plate 30 disposed on the upper plate 22 for the purpose of reinforcement. In this case, it is vital that the bolt holes 22a, 23a and 25a evade the groove 28.

The adhesive protective sheet 25 on the market will be illustrated. If, for example, the upper plate 22 is formed from PTFE, “RAP” (commercial name) of DAIKIN INDUSTRIES, which is an adhesive protective sheet comprising the same series of material as PTFE, was used, and bonded under pressure at a heating temperature of about 300° C. Satisfactory bond strength and anti-corrosion effect were obtained.

As described above, the channel-incorporating pedestal 21 of the present Embodiment 1 comprises the upper plate 22 and the lower plate 23 joined together, incorporates the groove 28, which is formed on the joining surface 22b of the upper plate 22, as the channel for the fluid, and brings the groove 28 into communication with the instruments 24, which are placed on the surface 22c of the upper plate 22, via the communication holes 29 formed in the upper plate 22. This channel-incorporating pedestal is characterized in that the upper plate 22 comprises the anticorrosive material, the lower plate 23 comprises the metallic material, and the upper plate 22 and the lower plate 23 are bonded together by the adhesive protective sheet 25 interposed between the upper plate 22 and the lower plate 23, the adhesive protective sheet 25 having a lower melting point than the melting points of the upper plate 22 and the lower plate 23, and being thermoplastic and anticorrosive.

The method for producing the channel-incorporating pedestal 21 of the present Embodiment 1 is a method for producing a channel-incorporating pedestal, which comprises the upper plate 22 and the lower plate 23 joined together, incorporates the groove 28, formed on the joining surface 22b of the upper plate 22, as the channel for the fluid, and brings the groove 28 into communication with the instruments 24, placed on the surface 22c of the upper plate 22, via the communication holes 29 formed in the upper plate 22. This method is characterized by using the anticorrosive material as the upper plate 22, using the metallic material as the lower plate 23, and pressurizing and heating the upper plate 22 and the lower plate 23, with the adhesive protective sheet 25 being interposed between the upper plate 22 and the lower plate 23, the adhesive protective sheet 25 having a lower melting point than the melting points of the upper plate 22 and the lower plate 23, and being thermoplastic and anticorrosive, to melt the adhesive protective sheet 25, thereby bonding the upper plate 22 and the lower plate 23 together by the adhesive protective sheet 25.

According to the present Embodiment 1, as described above, the upper plate 22 having the groove 28 and the communication holes 29 formed therein comprises the anticorrosive material, and the lower plate 23 comprising the metallic material is protected by the anticorrosive adhesive protective sheet 25. Thus, the upper plate 22 and the lower plate 23 have corrosion resistance, for example, to the corrosive fluid flowing in the groove 28. Furthermore, the lower plate 23 comprises the metallic material, so that the lower plate 23 can ensure the mechanical strength of the channel-incorporating pedestal 21. If further strength is needed, the further strength can be easily obtained simply by increasing the wall thickness of the lower plate 23. Moreover, the strength can be easily enhanced by clamping the upper plate 22 and the lower plate 23 by the bolt 26 and the nut 27 via the metal plate 30.

Besides, corrosion prevention can be easily performed simply by bonding the upper and lower plates 22 and 23 together by the adhesive protective sheet 25. For example, the lower plate 23 has the simplest flat surface. Thus, merely by applying a suitable pressurizing force and a suitable heating temperature to the adhesive protective sheet 25, satisfactory bonding force and anticorrosive performance can be ensured easily. Consequently, as compared with a conventional corrosion prevention measure such as aluminum oxide film coating, the channel-incorporating pedestal 21 with anticorrosive properties can be produced easily, and cost reduction can be achieved. If a synthetic resin such as PTFE is used as the material for the upper plate 22, the groove 28 and the communication holes 29 can be formed easily by a method such as machining, injection molding, or die casting. Thus, further cost reduction can be achieved.

### Embodiment 2

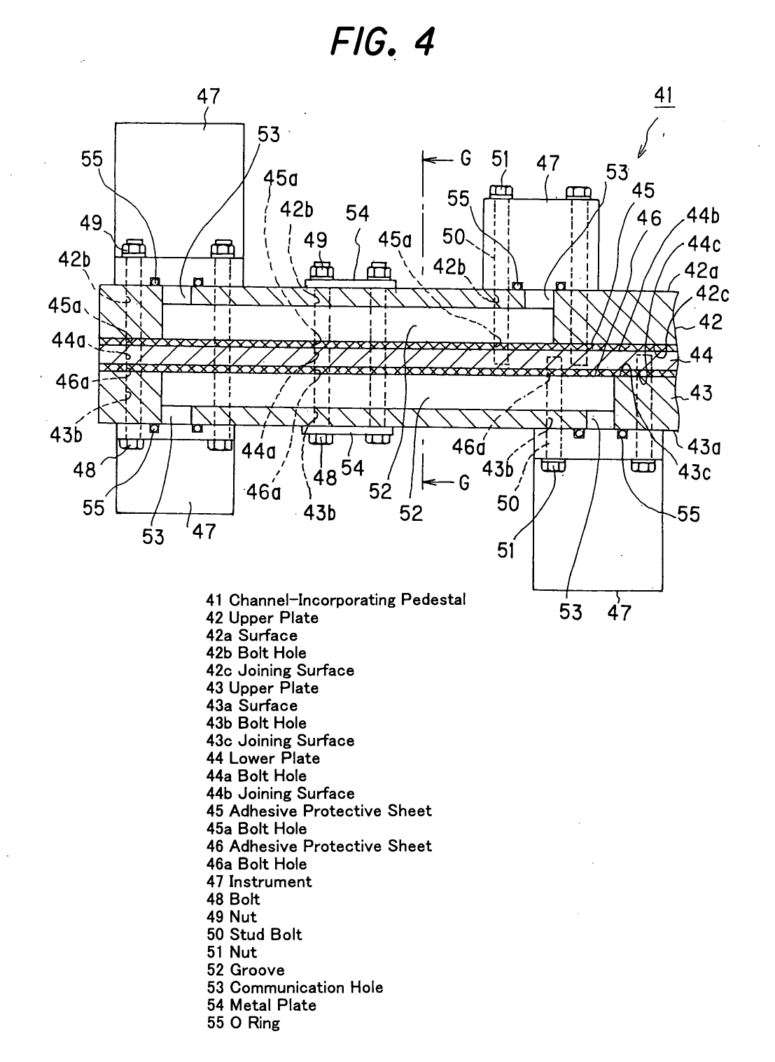

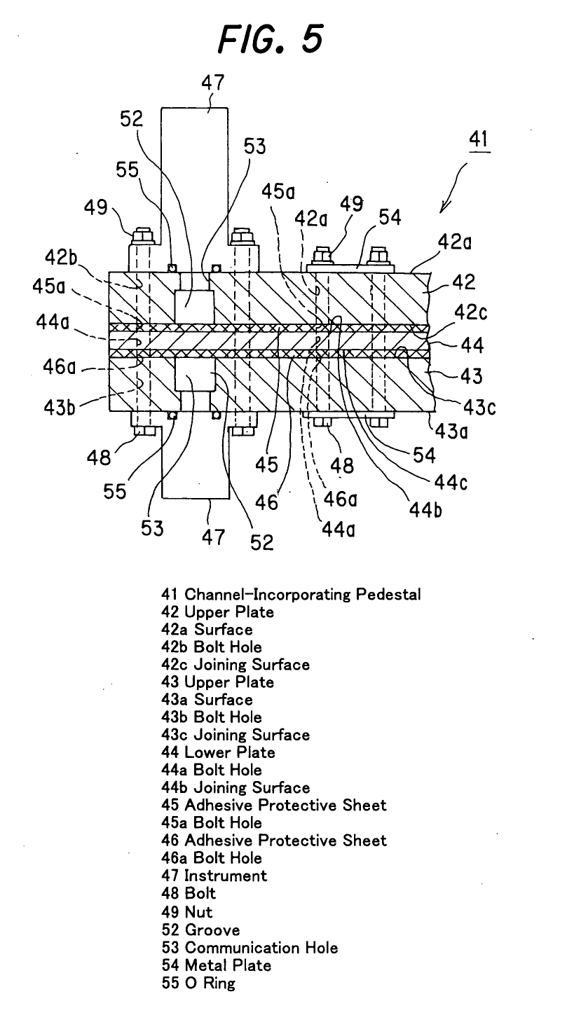

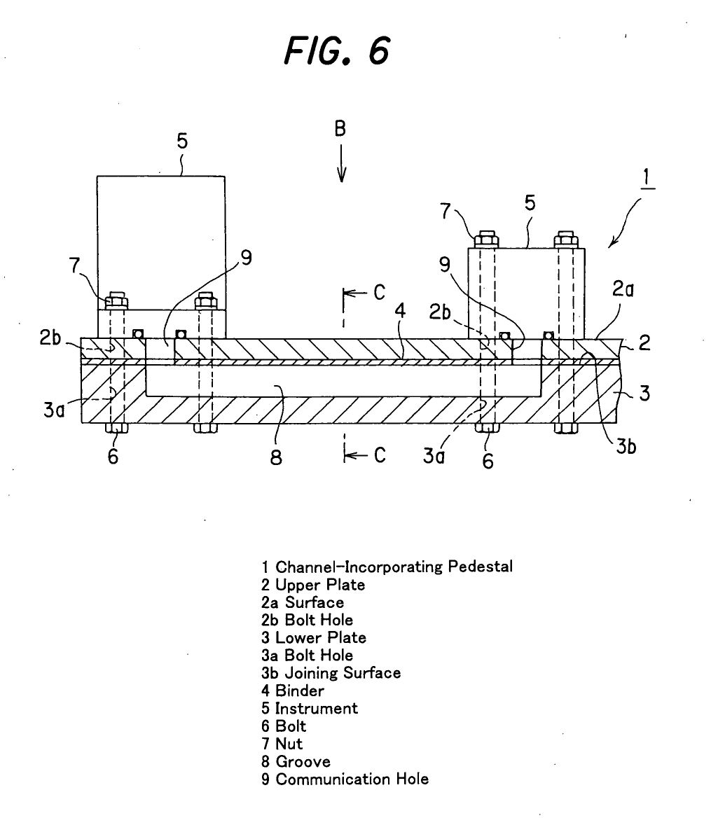

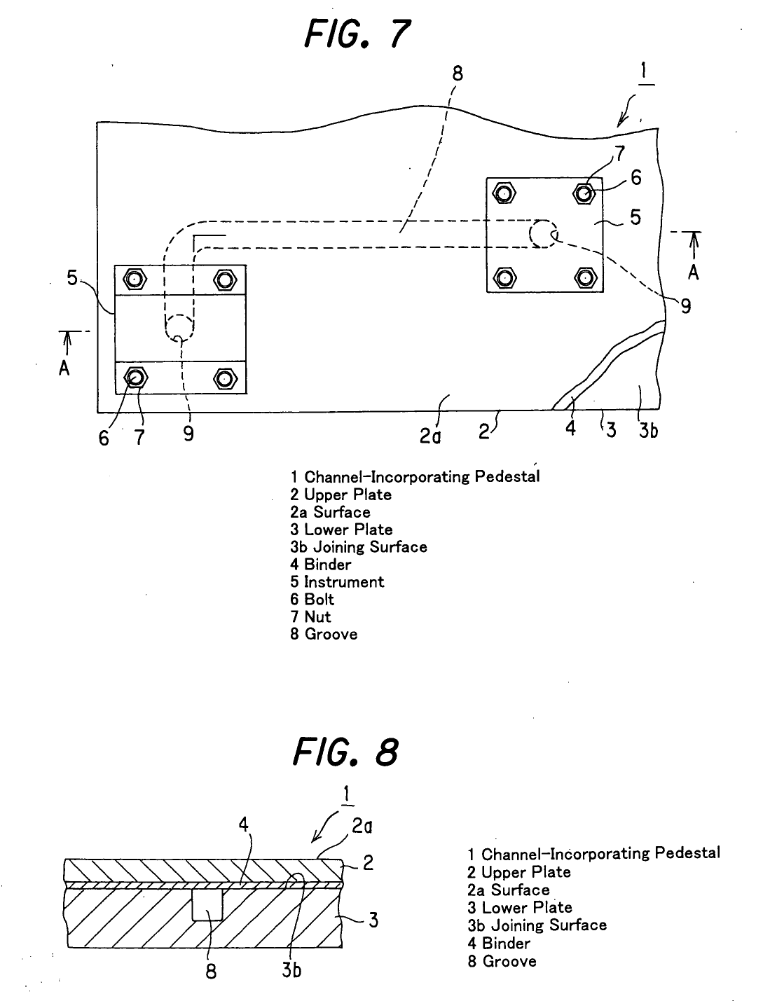

FIG. 4 is a sectional view showing the configuration of a channel-incorporating pedestal according to Embodiment 2 of the present invention. FIG. 5 is a sectional view taken on line G-G of FIG. 4.

As shown in FIGS. 4 and 5, a channel-incorporating pedestal 41 comprises an upper plate 42 as a first plate, an upper plate 43 as a third plate, and a lower plate 44 as a second plate joined together, with the lower plate 44 being interposed between the upper plate 42 and the upper plate 43. That is, the two upper plates 42 and 43 are stacked in opposed relation, with the lower plate 44 being interposed therebetween, to make up a multistage configuration. An adhesive protective sheet 45 is interposed between the upper plate 42 and the lower plate 44, and an adhesive protective sheet 46 is interposed between the upper plate 43 and the lower plate 44.

Various instruments 47, such as components and devices constituting, for example, a fuel cell power generation system or a fluid control system, are placed on the surface 42a of the upper plate 42 and the surface 43a of the upper plate 43. The instruments 47, which are placed in vertical alignment, are fixed by clamping, integrally with the upper and lower plates 42, 43 and 44, by bolts 48 inserted through bolt holes 42b, 43b, 44a, 45a, 46a formed in the upper and lower plates 42, 43 and 44 and the adhesive protective sheets 45 and 46, and nuts 49 screwed to the bolts 48. The instruments 47, which are placed out of vertical alignment, are fixed by clamping, integrally with the upper and lower plates 42, 44 or the upper and lower plates 43, 44, by stud bolts 50 driven into the lower plate 44 and inserted through the bolt holes 45a, 42b or the bolt holes 46a, 43b, and nuts 51 screwed to the stud bolts 50. That is, the channel-incorporating pedestal 41 functions as a pedestal for mounting the instruments 47.

Grooves 52 are formed in a joining surface 42c of the upper plate 42 and a joining surface 43c of the upper plate 43 by suitable means such as machining, injection molding, or die casting. Generally, a plurality of the grooves 52 are formed, have predetermined sectional areas (widths and depths), and are formed with suitable lengths in suitable directions. The lower plate 44 is joined to the upper plate 42 and the upper plate 43 via the adhesive protective sheets 45, 46 in such a manner as to cover the groove 52, as a first groove, formed in the upper plate 42, and the groove 52, as a second groove, formed in the upper plate 43. As a result, channels for fluids, which consist of the grooves 52, are formed within the channel-incorporating pedestal 41.

Communication holes 53 are formed in the upper plates 42, 43, directly below the instruments 47 disposed on the upper plates 42, 43, by suitable means such as machining, injection molding, or die casting. The groove 52 of the upper plate 42 is brought into communication with the instruments 47 on the upper plate 42 via the communication holes 53 of the upper plate 42. The groove 52 of the upper plate 43 is brought into communication with the instruments 47 on the upper plate 43 via the communication holes 53 of the upper plate 43. That is, the grooves 52 are incorporated, as the channels for fluids, in the channel-incorporating pedestal 41. These built-in channels (grooves 52) have the function of piping connecting the instruments 47 together. Thus, the channel-incorporating pedestal 41 also functions as integrated piping. The sectional area of each groove 52 (built-in channel) is determined by the properties, flow velocity and pressure loss of the fluid flowing in each groove 52, and the length and direction of each groove 52 (built-in channel) are determined, for example, by the arrangement of the instruments 47. A clearance between the communication hole 53 and the instrument 47 is sealed with an O ring 55.

The upper plates 42, 43 each comprise a nonmetallic material having corrosion resistance, and the lower plate 44 comprises a metallic material. Examples of the corrosion-resistant material are corrosion-free synthetic resins, such as fluoroplastic plates, for example, polytetrafluoroethylene (PTFE: Teflon). As examples of the metallic material, an aluminum plate and a steel plate can be named. The thickness of the lower plate 44 is a suitable thickness for required mechanical strength.

The adhesive protective sheets 45, 46 are thermoplastic and corrosion-resistant ones. A publicly known, commercially available product can be used as the adhesive protective sheets 45, 46. To be selected as the adhesive protective sheets 45, 46 is a sheet-shaped product which is based on the same material as that of the upper plates 42, 43, which has a suitable thickness, and which comprises, for example, a thermoplastic synthetic resin well compatible with and highly adhesive to the joining surfaces 44b, 44c of the lower plate 44. Furthermore, the adhesive protective sheets 45, 46 have to have a lower melting point than those of the upper plates 42, 43 and the lower plate 44. For example, if the material for the lower plate 44 is aluminum, and the material for the upper plates 42, 43 is PTFE, then a material having a lower melting point than the melting point of PTFE (327° C.) needs to be selected for the adhesive protective sheets 45, 46.

A method for producing the channel-incorporating pedestal 41 will be described. First, the adhesive protective sheet 45 is sandwiched (interposed) between the upper plate 42 and the lower plate 44 throughout the surfaces of the upper and lower plates 42 and 44. Also, the adhesive protective sheet 46 is sandwiched (interposed) between the upper plate 43 and the lower plate 44 throughout the surfaces of the upper and lower plates 43 and 44. Then, in this state, a suitable pressurizing means (pressing means) is applied to the upper and lower plates 42, 43, 44, such that the upper and lower plates 42, 43, 44 are clamped by a clamping device (not shown), or a heavy object is placed on the upper and lower plates 42, 43, 44. By this measure, the adhesive protective sheets 45, 46, together with the upper and lower plates 42, 43, 44, are pressurized (given pressure) under a suitable pressurizing force. Moreover, the adhesive protective sheets 45, 46, together with the upper and lower plates 42, 43, 44, are heated by a heating means, such as a baking furnace (heating furnace), to a suitable temperature at which the adhesive protective sheets 45, 46 are melted and adhered. The pressurizing force and the heating temperature differ according to the type of the adhesive protective sheets 45, 46. For example, the heating temperature is usually several hundred degrees centigrade.

As a result, the upper plate 42 and the lower plate 44 are bonded together by the adhesive protective sheet 45, and the upper plate 43 and the lower plate 44 are bonded together by the adhesive protective sheet 46.

Concretely, at the portion of joining between the upper and lower plates 42 and 44, namely, at a portion where the adhesive protective sheet 45 contacts the joining surface 42c of the upper plate 42 and the joining surface 44b of the lower plate 44 (i.e., the portion other than the portion corresponding to the groove 52 formed in the upper plate 42), the upper and lower plates 42 and 44 are bonded by the adhesive protective sheet 45. In the non-joining portion of the upper and lower plates 42 and 44, namely, the portion corresponding to the groove 52 formed in the upper plate 42, the adhesive protective sheet 45 is fusion bonded to the joining surface 44b of the lower plate 44, coating or lining the joining surface 44b. Thus, the adhesive protective sheet 45 protects the relevant portion of the lower plate 44 from a corrosive fluid flowing in the groove 52.

Similarly, at the portion of joining between the upper and lower plates 43 and 44, namely, at a portion where the adhesive protective sheet 46 contacts the joining surface 43c of the upper plate 43 and the joining surface 44c of the lower plate 44 (i.e., the portion other than the portion corresponding to the groove 52 formed in the upper plate 43), the upper and lower plates 43 and 44 are bonded by the adhesive protective sheet 46. In the non-joining portion of the upper and lower plates 43 and 44, namely, the portion corresponding to the groove 52 formed in the upper plate 43, the adhesive protective sheet 46 is fusion bonded to the joining surface 44c of the lower plate 44, coating or lining the joining surface 44c. Thus, the adhesive protective sheet 46 protects the relevant portion of the lower plate 44 from a corrosive fluid flowing in the groove 52.

Then, the instruments 47 are placed on the upper plates 42, 43, and they are clamped by the bolts 48, 50 and the nuts 49, 51 for fixing, whereby sufficient strength of the bonding surfaces can be ensured. Furthermore, if it is necessary to enhance the bond strength between the upper plates 42, 43 and the lower plate 44 because the fluids flowing in the grooves 52 are set at a high pressure, the upper and lower plates 42, 43, 44 and the adhesive protective sheets 45, 46 may be clamped together by the bolts 48 and the nuts 49 via suitable metal plates 54 disposed on the upper plates 42, 43 for the purpose of reinforcement. In this case, it is vital that the bolt holes 42b, 43b, 45a, 46a evade the grooves 52.

As described above, the channel-incorporating pedestal 41 of the present Embodiment 2 comprises the upper and lower plates 42, 43 and 44 joined together, with the lower plate 44 being interposed between the upper plates 42 and 43, incorporates the grooves 52, which are formed on the joining surfaces 42c, 43c of the upper plates 42, 43, as the channels for fluids, brings the groove 52 of the upper plate 42 into communication with the instruments 47, which are placed on the surface 42a of the upper plate 42, via the communication holes 53 formed in the upper plate 42, and brings the groove 52 of the upper plate 43 into communication with the instruments 47, which are placed on the surface 43a of the upper plate 43, via the communication holes 53 formed in the upper plate 43. This channel-incorporating pedestal is characterized in that the upper plates 42, 43 comprise the anticorrosive material, the lower plate 44 comprises the metallic material, the upper plate 42 and the lower plate 44 are bonded together by the adhesive protective sheet 45 interposed between the upper and lower plates 42 and 44, the adhesive protective sheet 45 having a lower melting point than the melting points of the upper and lower plates 42, 43, 44, and being thermoplastic and anticorrosive, and the upper plate 43 and the lower plate 44 are bonded together by the adhesive protective sheet 46 interposed between the upper and lower plates 43 and 44, the adhesive protective sheet 46 having a lower melting point than the melting points of the upper and lower plates 42, 43, 44, and being thermoplastic and anticorrosive.

The method for producing the channel-incorporating pedestal 41 of the present Embodiment 2 is a method for producing a channel-incorporating pedestal, which comprises the upper and lower plates 42, 43, 44 joined together, with the lower plate 44 being interposed between the upper plates 42 and 43, incorporates the grooves 52, formed on the joining surfaces 42c, 43c of the upper plates 42, 43, as the channels for fluids, brings the groove 52 into communication with the instruments 47, placed on the surface 42a of the upper plate 42, via the communication holes 53 formed in the upper plate 42, and brings the groove 52 into communication with the instruments 47, placed on the surface 43a of the upper plate 43, via the communication holes 53 formed in the upper plate 43. This method is characterized by using the anticorrosive material as the upper plates 42, 43, using the metallic material as the lower plate 44, and pressurizing and heating the upper and lower plates 42, 43, 44, with the adhesive protective sheet 45 being interposed between the upper plate 42 and the lower plate 44, the adhesive protective sheet 45 having a lower melting point than the melting points of the upper and lower plates 42, 43, 44, and being thermoplastic and anticorrosive, and with the adhesive protective sheet 46 being interposed between the upper plate 43 and the lower plate 44, the adhesive protective sheet 46 having a lower melting point than the melting points of the upper and lower plates 42, 43, 44, and being thermoplastic and anticorrosive, to melt the adhesive protective sheets 45, 46, thereby bonding the upper plate 42 and the lower plate 44 together by the adhesive protective sheet 45, and bonding the upper plate 43 and the lower plate 44 together by the adhesive protective sheet 46.

According to the present Embodiment 2, the upper plates 42, 43 having the grooves 52 and the communication holes 53 formed therein comprise the anticorrosive material, and the lower plate 44 comprising the metallic material is protected by the anticorrosive adhesive protective sheets 45, 46. Thus, the upper and lower plates 42, 43, 44 have corrosion resistance, for example, to the corrosive fluid flowing in the grooves 52. Furthermore, the lower plate 44 comprises the metallic material, so that the lower plate 44 can ensure the mechanical strength of the channel-incorporating pedestal 41. If further strength is needed, the further strength can be easily obtained simply by increasing the wall thickness of the lower plate 44. Moreover, the strength can be easily enhanced by clamping the upper and lower plates 42, 43, 44 by the bolts 48 and the nuts 49 via the metal plate 54.

Besides, corrosion prevention can be easily performed simply by bonding the upper and lower plates 42, 43 and 44 together by the adhesive protective sheets 45,46. For example, the lower plate 44 has the simplest flat surface. Thus, merely by applying a suitable pressurizing force and a suitable heating temperature to the adhesive protective sheets 45, 46, satisfactory bonding force and anticorrosive performance can be ensured easily. Consequently, as compared with a conventional corrosion prevention measure such as aluminum oxide film coating, the channel-incorporating pedestal 41 with anticorrosive properties can be produced easily, and cost reduction can be achieved. If a synthetic resin such as PTFE is used as the material for the upper plate 42, the groove 52 and the communication holes 53 can be easily formed by a method such as machining, injection molding, or die casting. Thus, further cost reduction can be achieved. Furthermore, a multistage channel-incorporating pedestal, which is compact and lightweight, can be produced.

As described above, the present invention relates to a channel-incorporating pedestal, which is useful when applied in preventing the occurrence of cracks in weld lines surrounding the groove and the corrosion of the weld lines to maintain the sealing function of the weld lines.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A channel-incorporating pedestal
comprising a first plate and a second plate joined together,
incorporating a groove, which is formed on a joining surface of said first plate, as a channel for a fluid, and
bringing said groove into communication with an instrument, which is placed on a surface of said first plate, via a communication hole formed in said first plate, and
wherein said first plate comprises an anticorrosive material,
said second plate comprises a metallic material, and
said fist plate and said second plate are bonded together by an adhesive protective sheet interposed between said first plate and said second plate, said adhesive protective sheet having a lower melting point than melting points of said first plate and said second plate, and being thermoplastic and anticorrosive.

2. A channel-incorporating pedestal
comprising a first plate, a second plate, and a third plate joined together, with said second plate being interposed between said first plate and said third plate,
incorporating a first groove, which is formed on a joining surface of said first plate, and a second groove, which is formed on a joining surface of said third plate, as channels for fluids,
bringing said first groove into communication with an instrument, which is placed on a surface of said first plate, via a first communication hole formed in said first plate, and
bringing said second groove into communication with an instrument, which is placed on a surface of said third plate, via a second communication hole formed in said third plate, and
wherein said first plate and said third plate comprise an anticorrosive material,
said second plate comprises a metallic material,
said fist plate and said second plate are bonded together by a first adhesive protective sheet interposed between said first plate and said second plate, said first adhesive protective sheet having a lower melting point than melting points of said first plate, said second plate, and said third plate, and being thermoplastic and anticorrosive, and
said third plate and said second plate are bonded together by a second adhesive protective sheet interposed between said third plate and said second plate, said second adhesive protective sheet having a lower melting point than melting points of said first plate, said second plate, and said third plate, and being thermoplastic and anticorrosive.

3. A method for producing a channel-incorporating pedestal,
said channel-incorporating pedestal
comprising a first plate and a second plate joined together,
incorporating a groove, which is formed on a joining surface of said first plate, as a channel for a fluid, and
bringing said groove into communication with an instrument, which is placed on a surface of said first plate, via a communication hole formed in said first plate,
said method comprising
using a plate comprising an anticorrosive material as said first plate,
using a plate comprising a metallic material as said second plate, and
pressurizing and heating said fist plate and said second plate, with an adhesive protective sheet being interposed between said first plate and said second plate, said adhesive protective sheet having a lower melting point than melting points of said first plate and said second plate, and being thermoplastic and anticorrosive, to melt said adhesive protective sheet, thereby bonding said first plate and said second plate together by said adhesive protective sheet.

4. A method for producing a channel-incorporating pedestal, said channel-incorporating pedestal
comprising a first plate, a second plate, and a third plate joined together, with said second plate being interposed between said first plate and said third plate,
incorporating a first groove, which is formed on a joining surface of said first plate, and a second groove, which is formed on a joining surface of said third plate, as channels for fluids,
bringing said first groove into communication with an instrument, which is placed on a surface of said first plate, via a first communication hole formed in said first plate, and
bringing said second groove into communication with an instrument, which is placed on a surface of said third plate, via a second communication hole formed in said third plate,
said method comprising
using plates comprising an anticorrosive material as said first plate and said third plate,
using a plate comprising a metallic material as said second plate,
pressurizing and heating said fist plate, said second plate, and said third plate, with a first adhesive protective sheet being interposed between said first plate and said second plate, said first adhesive protective sheet having a lower melting point than melting points of said first plate, said second plate, and said third plate, and being thermoplastic and anticorrosive, and with a second adhesive protective sheet being interposed between said third plate and said second plate, said second adhesive protective sheet having a lower melting point than melting points of said first plate, said second plate, and said third plate, and being thermoplastic and anticorrosive, to melt said first adhesive protective sheet and said second adhesive protective sheet, thereby bonding said first plate and said second plate together by said first adhesive protective sheet, and bonding said third plate and said second plate together by said second adhesive protective sheet.
